(19) United States
(12) Patent Application Publication
(10) Pub. No.: US 2014/0319123 A1
(43) Pub. Date: Oct. 30, 2014

(54) CONTROLLER FOR TEXTILE HEATING DEVICE

(71) Applicant: SUNBEAM PRODUCTS, INC., Baca Raton, FL (US)

(72) Inventor: Gabriel Kohn, Boca Raton, FL (US)

(73) Assignee: Sunbeam Products, Inc., Boca Raton, FL (US)

(21) Appl. No.: 13/869,549

(22) Filed: Apr. 24, 2013

(51) Int. Cl. H05B 1/02; G05D 23/19; H05B 3/34

(52) U.S. Cl. CPC H05B 1/0272; H05B 3/342; G05D 23/1917
USPC 219/506; 219/529

(57) ABSTRACT

A controller for use in textile heating devices, such as heating pads, heating blankets, and the like is provided. The controller provides a display system for conveying to a user the selected heat setting. Such display system is useful in low light condition, where a user cannot readily see the heat setting indicia on the controller. The display system includes a plurality of lighted elements. The lighted elements are illuminated at different intensity levels to indicate the selected heat setting, In this manner, a user is provided with a visual frame of reference to indicate the selected heating setting. Namely, the differentiation between the intensity levels enables a user to visual determine the selected heating setting by the position of a higher intensity lighted element in relationship to lesser intensity lighted elements.

### CROSS-REFERENCE TO RELATED APPLICATION

The preset invention claims priority to U.S. Provisional Application No. 61/620596 entitled HEAT SELECTION CONCEPT FOR ELECTRIC BEDDING, filed on Apr. 27, 2012, the contents of which are herein incorporated by reference in its entirety.

### FIELD OF THE INVENTION

The invention relates to a controller for textile heating devices, and more particularly to a controller using differing intensity lighted elements to convey the selected heat setting to a user.

### BACKGROUND OF THE INVENTION

Textile heating devices, such as heating pads, heating blanket and the like, can be used to keep individuals or certain muscles of an individual warm. A heating pad generally includes opposing layers of cloth material having a heating element disposed there between. The heating element is connectable to an electrical power source through a controller which controls the amount of heat output from the heating element.

The heating element may, for example, be heated by resistance via electricity, and may be provided as one or more metallic wires threaded throughout the pad. The shape and size of the metallic wires may vary, and in some cases the wires may actually be small metallic threads. The heating element may include a wire construction which is made of a center conductor which has Positive Temperature Coefficient (PTC) characteristics. Around the center PTC wire is a layer of Negative Temperature Coefficient (NTC) material. An electric heating pad is typically plugged into a power outlet so that power may be supplied to the heating element, causing the production of heat. In this manner, the heating pad may be used to warm a desired area of the body.

### SUMMARY OF THE INVENTION

The present disclosure is directed to a controller for use in textile heating devices, such as heating pads, heating blankets, and the like. The controller provides a display system for convey to a user the selected heat setting. Such display system is useful in low light conditions, where a user cannot readily see the heat setting indicia on the controller.

An exemplary heating device includes heating element and a controller operably connected to the heating element. The controller includes microprocessor electrically connectable to a power source. A mode selector switch is provided to turn on the heating device and select a heat setting.

The controller also includes indicator for displaying the selected heat setting of the heating element. The indicator can include a plurality of lighted elements. The lighted elements can be LCD type elements. However, it will be appreciated that any suitable lighting may be used, such as LEDs for example.

In operation, the controller is electrically connected to the power source to provide power to the heating pad. The mode selector switch is used to select one of a plurality of heat settings for the heating device, for example, “WARM,” “LOW,” “MED”, “MED/HIGH,” and “HIGH.”

Once the heating device is actuated and a user selects a heat setting, the microprocessor actuates a switch circuit such that current flows to the heating element so as to cause it to radiate heat. The microprocessor illuminates the lighted element corresponding to the selected heat setting at a first intensity level and the remaining lighted elements at a second intensity level, where the second intensity level is at a lesser (dimmer) intensity then the first intensity level.

In this manner, a user is provided with a visual frame of reference to indicate the selected heat setting. Namely, the differentiation between the first intensity level and the second intensity level enables a user to visual determine the selected heating setting by the position of the higher intensity lighted element in relationship to the lesser intensity lighted elements.

It will be appreciated by persons skilled in the art that the preset invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a schematic diagram of a textile heating device of the present disclosure;

FIG. 2 depicts a controller for the textile heating device of the present disclosure;

FIG. 3 depicts an exemplary partial circuit diagram of the controller; and

FIG. 4 depicts a flow chart for controlling the lighted elements of the controller.

### DETAILED DESCRIPTION OF THE INVENTION

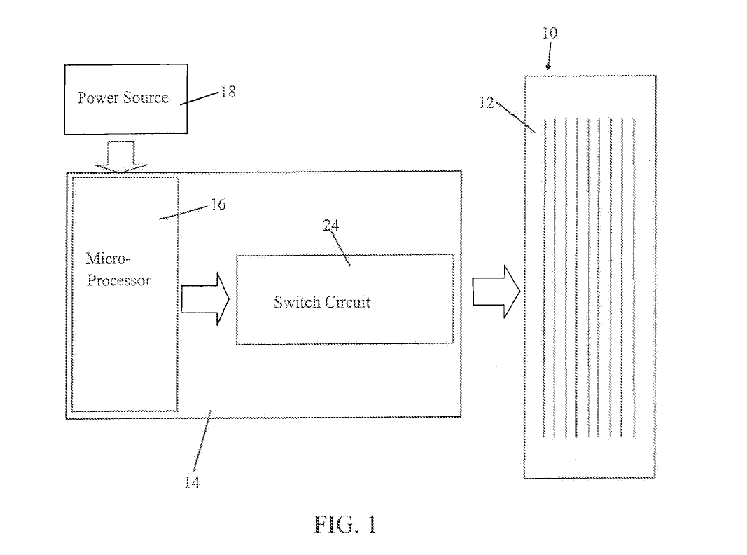

Referring to the drawing figures in which like reference designators refer to like elements, there is shown in FIG. 1 a schematic view of a textile heating device 10, exemplary heating pad, in accordance with the present disclosure. Heating pad 10 includes heating element 12. A controller 14 is operably connected to the heating element 12 in the heating pad 10 to provide power there to.

The controller 14 includes microprocessor 16 electrically connectable to a power source 18. Output of microprocessor 16 is operatively connected to heating element 12 of heating pad 10 by a switch circuit 24.

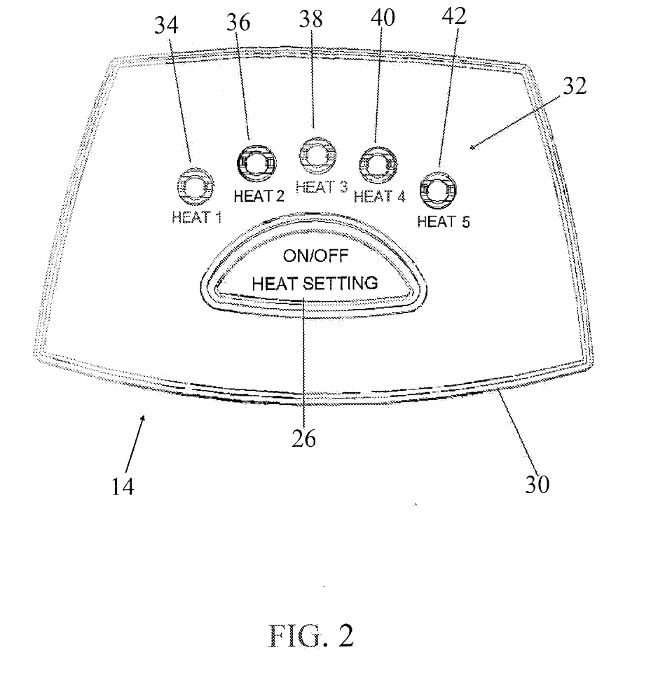

Referring also to FIG. 2, in operation, the controller 14 is electrically connected to the power source 18 to provide power to the heating pad 10. The power source 18 can have a predetermined voltage and frequency, e.g. 120 VAC at 60 Hz, via a standard electrical plug. A mode selector switch 26 is used to select one of a plurality of heat settings for the heating pad 10. By way of example, these heat settings may include “WARM,” “LOW” “MED”, “MED/HIGH,” and “HIGH.”

Once heating pad 10 is actuated and a user-desired heat setting is selected, microprocessor 16 actuates switch circuit 24 such that current flows to heating element 12 so as to cause it to radiate heat. In an embodiment, the controller 14 can provide power to the heating element 12 such that the heating pad 10 operates at 50 watts. Alternatively, the controller 14 can provide power to the heating element 12 such that the heating pad 10 operates at 100 watts. The increased wattage allowing the heating element 14 to heat up to the selected heat setting in a shorter time period. The above noted operating wattages are exemplary in nature, and it is contemplated that the heating pad 10 can operate at other wattages.

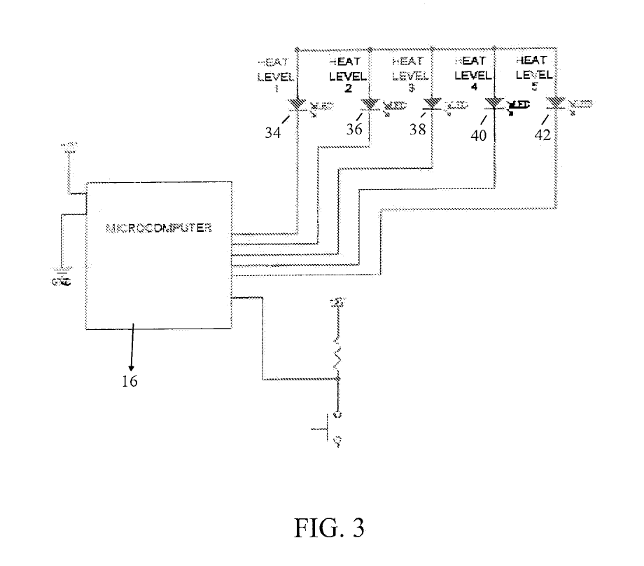

Referring to FIGS. 2 and 3, the controller 14 includes a housing 30 having the mode selector switch 26. Controller 14 also includes indicator 32 for displaying the selected heat setting of the heating element 12. The indicator 32 includes a plurality of lighted elements 34, 36, 38, 40, and 42. The lighted elements 34, 36, 38, 40, and 42 can be any suitable lighting elements, such as LEDs for example.

The lighted elements 34, 36, 38, 40, and 42 are operatively connected to the microprocessor 16. When the power is turned “ON” and a heat setting is selected utilizing the mode selector switch 26, the microprocessor 16 illuminates the corresponding lighted element 34, 36, 38, 40, or 42 at a first intensity level. The microprocessor 16 also illuminates the remaining lighted elements 34, 36, 38, 40, or 42 at a second intensity level, where the second level is at a lesser (dimmer) intensity then the first intensity level.

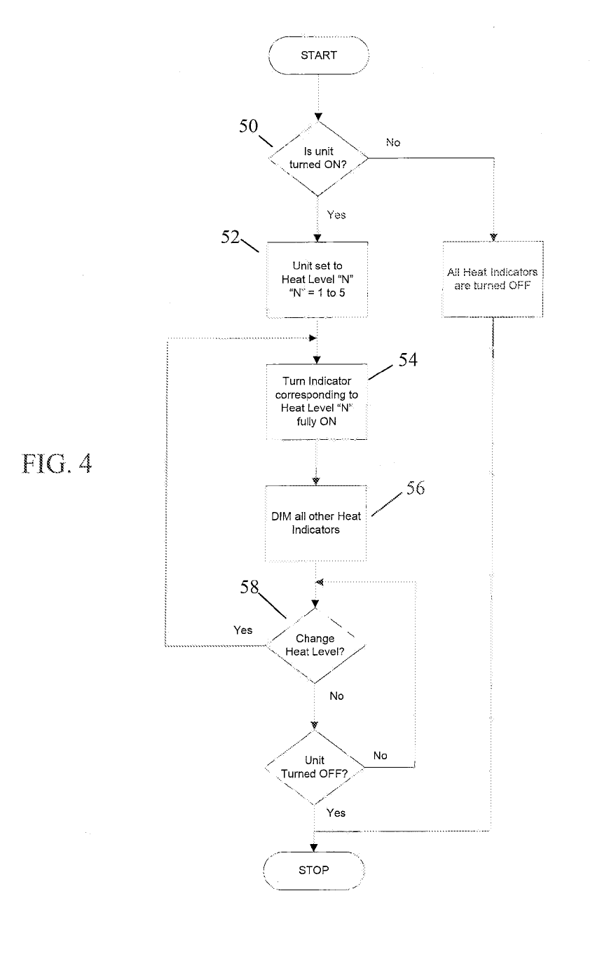

Referring to FIG. 4, in use, a user utilized the mode selector switch 26 to turn “ON” 50 the heating pad 10. The mode selector switch 26 can likewise be used to select the heat setting 52, setting 1-5. The microprocessor 16 illuminates 54 the lighted element corresponding to the selected heat setting at the first intensity level. The microprocessor 16 also illuminates 56 the lighted elements for the non-selected heat setting at the second intensity level.

In this manner, a user is provided with a visual frame of reference to indicate the selected heating setting. Namely, the differentiation between the first intensity level and the second intensity level enables a user to visual determine the selected heating setting by the position of the higher intensity lighted element in relationship to the lesser intensity lighted elements.

If a user changes the selected heat setting 58, the process is repeated where the microprocessor 16 changes the illumination of the lighted element 34, 36, 38, 40, and 44 to correspond to the newly selected heating setting.

For example, the heat selector switch 26 can be used to select heat setting 3, medium. The microprocessor 16 illuminates the corresponding lighted element, lighted element 38, at the at the first intensity level. The microprocessor 16 also illuminates the remaining non-selected lighted elements, lighted elements 34, 36, 40, and 42, at the second intensity level. In the manner, a user is provided with a visual frame of reference to indicate the selection of heat level 3. Namely, the differentiation between the illuminated first intensity level of lighted element 38 and the illuminated second intensity level of lighted elements 34, 36, 40 and 42 enables a user to visual determine that the selected heat level is heat lever 3 by the position of the higher intensity lighted element 38 in relationship to the lesser intensity lighted elements 34, 36, 40, and 42.

If the user changes the heat setting 58, selecting heat setting 5, high. The microprocessor 16 changes the illumination of the lighted elements 34, 36, 38, 40, and 42. The microprocessor 16 illuminates the lighted element corresponding to heat setting 5, lighted element 42, at the first intensity level. The microprocessor 16 also illuminates the remaining non selected lighted elements, lighted elements 34, 36, 38, and 40, at the second intensity level. In the manner, a user is provided with a visual frame of reference to indicate the selection of heat setting 5. Namely, the differentiation between the illuminated first intensity level of lighted element 44 and the illuminated second intensity level of lighted elements 34, 36, 38, and 40 enables a user to visual determine that the selected heat setting is heat setting 5 by the position of the higher intensity lighted element 44 in relationship to the lesser intensity lighted elements 34, 36, 38, and 40.

in another embodiment, the lighted elements 34, 36, 38, 40, and 42 can be illuminated in two or more colors. The lighted elements 34, 36, 38, 40, and. 42 are operatively connected to the microprocessor 16. When the power is turned “ON” and a heat setting is selected utilizing the mode selector switch 26, the microprocessor 16 illuminates the corresponding lighted element 34, 36, 38, 40, or 42 at a first color. The microprocessor 16 also illuminates the remaining lighted element 34, 36, 38, 40, or 42 at a second color, where the second color is different than the first color.

In this manner, a user is provided with a visual frame of reference to indicate the selected heating setting. Namely, the differentiation between the first color and the second color enables a user to visual determine the selected heating setting by the position of the first color lighted element in relationship to the second color lighted elements.

For example, the heat selector switch 26 can be used to select heat setting 3, medium. The microprocessor 16 illuminates the corresponding lighted element, lighted element 38, at a first color, green. The microprocessor 16 also illuminates the remaining non-selected lighted elements, lighted elements 34, 36, 40, and 42, at a second color, red. In the manner, a user is provided with a visual frame of reference to indicate the selection of heat level 3. Namely, the differentiation between the green illumination of lighted element 38 and the red illumination of lighted elements 34, 36, 40 and 42 enables a user to visual determine that the selected heat level is heat lever 3 by color of lighted element 38 in relationship to the color of lighted elements 34, 36, 40, and 42.

Additionally, the microprocessor 16 can illuminate the first color lighted element 34, 36, 38, 40, or 42 at a first intensity level. The microprocessor 16 can also illuminates the second color lighted element 34, 36, 38, 40, or 42 at a second intensity level, where the second level is at a lesser (dimmer) intensity then the first intensity level.

In this manner, a user is provided with a further visual frame of reference to indicate the selected heating setting. Namely, the differentiation between the first color and first intensity level and the second color and second intensity level enables a user to visual determine the selected heating setting by the position of the first color/intensity lighted element in relationship to the second color/intensity lighted elements.

All references cited herein are expressly incorporated by reference in their entirety.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A controller for use with an electric appliance comprising:
a microprocessor;
a mode selector switch connected to the microprocessor, the mode selector switch being utilized to select a mode of operation; and
an indicator display, wherein the indicator display provides mode selection information.

2. A controller for use with an electric appliance as set forth in claim 1, the indicator display comprising a plurality of lighted elements, each of the lighted elements corresponding to a mode of operation.

3. A controller for use with an electric appliance as set forth in claim 2, wherein the plurality of lighted elements are illuminated according to the selected mode of operation, the lighted element corresponding to the selected mode of operation being illuminated at a first intensity, and the remaining lighted elements be illuminated at a second intensity.

4. A controller for use with an electric appliance as set forth in claim 3, wherein the first intensity is greater than the second intensity.

5. A controller for use with an electric appliance as set forth in claim 2, wherein the plurality of lighted elements can be illuminated in one or more colors.

6. A controller for use with a electric appliance as set forth in claim 6, wherein the plurality of lighted elements are illuminated according to the selected mode of operation, wherein the lighted element corresponding to the selected mode of operation being illuminated in a first color, and the remaining lighted elements being illuminated in a second color.

7. A textile heating device comprising:
a heating element;
a controller operatively connected to the heating element, and including:
a microprocessor;
a mode selector switch connected to the microprocessor, the mode selector switch being utilized to select a heat setting; and
an indicator display, wherein the indicator display provides heat setting information.

8. A textile heating device as set forth in claim 7, the indicator display comprising a plurality of lighted elements, each of the lighted elements corresponding to a heat setting.

9. A textile heating device as set forth in claim 8, wherein the plurality of lighted elements are illuminated according to the selected heat setting, wherein the lighted element corresponding to the selected heat setting is illuminated at a first intensity level, and the lighted elements for the non-selected heat setting are illuminated at a second intensity level.

10. A textile heating device as set forth in claim 9, wherein the first intensity level is greater than the second intensity level.

11. A textile heating device as set forth in claim 8, wherein the plurality of lighted elements can be illuminated in one or more colors.

12. A textile heating device as set forth in claim 11, wherein the plurality of lighted elements are illuminated according to the selected heat setting, wherein the lighted element corresponding to the selected heat setting is illuminated in a first color, and the non-selected lighted elements are illuminated in a second color.

13. A method of conveying information regarding a selected mode of operation of an electric appliance, the electric appliance comprising a microprocessor; a mode selector switch connected to the microprocessor, the mode selector switch being utilized to select a mode of operation; and an indicator display, the method comprising:
selecting a mode of operation of the electric appliance;
displaying the selected mode of operation on the indicator display, wherein the indicator display comprises a plurality of lighted elements, each of the lighted elements corresponding to a mode of operation.

14. A method of conveying information regarding a selected mode of operation of an electric appliance as set forth in claim 13, wherein the plurality of lighted elements are illuminated according to the selected mode of operation, the lighted element corresponding to the selected mode of operation being illuminated at a first intensity, and the remaining lighted elements being illuminated at a second intensity.

15. A method of conveying information regarding a selected mode of operation of an electric appliance as set forth in claim 14, wherein the first intensity is greater than the second intensity.

16. A method of conveying information regarding a selected mode of operation of an electric appliance as set forth in claim 13, wherein the plurality of lighted elements can be illuminated in one or more colors.

17. A method of conveying information regarding a selected mode of operation of an electric appliance as set forth in claim 16, wherein the plurality of lighted elements are illuminated according to the selected mode of operation, wherein the lighted element corresponding to the selected mode of operation is illuminated in a first color, and the remaining lighted elements are illuminated in a second color.

18. A method of conveying information regarding a selected mode of operation of an electric appliance 13, wherein the electric appliance is a textile heating device and the mode of operations are heat settings.

19. A method of conveying information regarding a selected mode of operation of an electric appliance as set forth in 18, wherein the indicator display comprises a plurality of lighted elements, each of the lighted elements corresponding to a heat setting and the plurality of lighted elements are illuminated according to the selected heat setting, wherein the lighted element corresponding to the selected heat setting is illuminated at a first intensity level, and the lighted elements for the non-selected heat setting are illuminated at a second intensity level.

20. A method of conveying information regarding a selected mode of operation of an electric appliance as set forth in 19, wherein the first intensity level is greater than the second intensity level.
